(19) United States
(12) Patent Application Publication
(10) Pub. No.: US 2014/0304649 A1
(43) Pub. Date: Oct. 9, 2014

(54) TRUSTED USER INTERACTION

(71) Applicants: Vinay Phegade, Beaverton, OR (US); Conor Cahill, Waterford, VA (US); Jason Martin, Beaverton, OR (US)

(72) Inventors: Vinay Phegade, Beaverton, OR (US); Conor Cahill, Waterford, VA (US); Jason Martin, Beaverton, OR (US)

(21) Appl. No.: 13/977,662

(22) PCT Filed: Apr. 16, 2012
(86) PCT No.: PCT/US12/33780

§ 371 Date: May 23, 2014

(51) Int. Cl. G06F 21/62; G06F 3/0484

(52) U.S. Cl. CPC G06F 21/629; G06F 3/04842
USPC 715/809

(57) ABSTRACT

In one embodiment a controller comprises a memory module, and logic configured to receive a request for trusted input from a user, define, on a region of a display device coupled to the secure controller, a dialog box, lock the dialog box such that input/output operations conducted in the dialog box are visible only to the secure controller, present, in the dialog box, one or more anti-spoof indicators and at least one input mechanism, receive a user input from the at least one input mechanism and process the user input in the secure controller. Other embodiments may be described.

### BACKGROUND

The subject matter described herein relates generally to the field of electronic devices and more particularly to a system and method to implement trusted user interaction using electronic devices.

Malicious software (malware) may be used to steal personal information, including payment credentials, for use by unauthorized individuals. By way of example, malware can steal a user's confidential input by spoofing a display or by snooping input into a display module. This threat has an effect on a percentage of the population who will not conduct online activity due to fear of having their information compromised. This reduces efficiencies that can be gained through online commerce and limits the amount of goods and services purchased by concerned individuals, limiting the growth of online commerce.

Existing solutions to these problems are limited in their usefulness and/or security due to the fact that they are hosted inside an electronic device's operating system, which is always a point of vulnerability, or require external, attached hardware devices, which limit consumer ease-of-use factors. Accordingly systems and techniques to provide a secure computing environment for electronic commerce may find utility.

### BRIEF DESCRIPTION OF THE DRAWINGS

The detailed description is described with reference to the accompanying figures. FIG. 1 is a schematic illustration of an exemplary electronic device which may be adapted to include infrastructure for trusted user interaction in accordance with some embodiments.

FIG. 2 is a high-level schematic illustration of an exemplary architecture for trusted user interaction in accordance with some embodiments.

FIGS. 3-4 are flowchart illustrating operations in a method to implement trusted user interaction in accordance with some embodiments.

FIG. 5 is a schematic illustration of an electronic device which may be adapted to implement trusted user interaction in accordance with some embodiments.

### DETAILED DESCRIPTION

Described herein are exemplary systems and methods to implement trusted user interaction in electronic devices. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

FIG. 1 is a schematic illustration of an exemplary system 100 which may be adapted to implement trusted user interaction in accordance with some embodiments. In one embodiment, system 100 includes an electronic device 108 and one or more accompanying input/output devices including a display 102 having a screen 104, one or more speakers 106, a keyboard 110, one or more other I/O device(s) 112, and a mouse 114. The other I/O device(s) 112 may include a touch screen, a voice-activated input device, a track ball, a geolocation device, an accelerometer/gyroscope and any other device that allows the system 100 to receive input from a user.

In various embodiments, the electronic device 108 may be embodied as a personal computer, a laptop computer, a personal digital assistant, a mobile telephone, an entertainment device, or another computing device. The electronic device 108 includes system hardware 120 and memory 130, which may be implemented as random access memory and/or read-only memory. A file store 180 may be communicatively coupled to computing device 108. File store 180 may be internal to computing device 108 such as, e.g., one or more hard drives, CD-ROM drives, DVD-ROM drives, or other types of storage devices. File store 180 may also be external to computer 108 such as, e.g., one or more external hard drives, network attached storage, or a separate storage network.

System hardware 120 may include one or more processors 122, graphics processors 124, network interfaces 126, and bus structures 128. In one embodiment, processor 122 may be embodied as an Intel ® Core2 Duo® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 124 may function as adjunct processor that manages graphics and/or video operations. Graphics processor(s) 124 may be integrated into the packaging of processor(s) 122, onto the motherboard of computing system 100 or may be coupled via an expansion slot on the motherboard. In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN--Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

Memory 130 may include an operating system 140 for managing operations of computing device 108. In one embodiment, operating system 140 includes a hardware interface module 154 that provides an interface to system hardware 120. In addition, operating system 140 may include a file system 150 that manages files used in the operation of computing device 108 and a process control subsystem 152 that manages processes executing on computing device 108.

Operating system 140 may include (or manage) one or more communication interfaces that may operate in conjunction with system hardware 120 to transceive data packets and/or data streams from a remote source. Operating system 140 may further include a system call interface module 142 that provides an interface between the operating system 140 and one or more application modules resident in memory 130. Operating system 140 may be embodied as a UNIX operating system or any derivative thereof (e.g., Linux, Solaris, etc.) or as a Windows® brand operating system, or other operating systems.

In some embodiments system 100 may comprise a low-power embedded processor, referred to herein as a trusted execution complex 170. The trusted execution complex 170 may be implemented as an independent integrated circuit located on the motherboard of the system 100. In the embodiment depicted in FIG. 1 the trusted execution complex 170 comprises a processor 172, a memory module 174, an authentication module 176, an I/O module 178, and a secure sprite generator 179. In some embodiments the memory module 164 may comprise a persistent flash memory module and the authentication module 174 may be implemented as logic instructions encoded in the persistent memory module, e.g., firmware or software. The I/O module 178 may comprise a serial I/O module or a parallel I/O module. Because the trusted execution complex 170 is physically separate from the main processor(s) 122 and operating system 140, the trusted execution complex 170 may be made secure, i.e., inaccessible to hackers such that it cannot be tampered with.

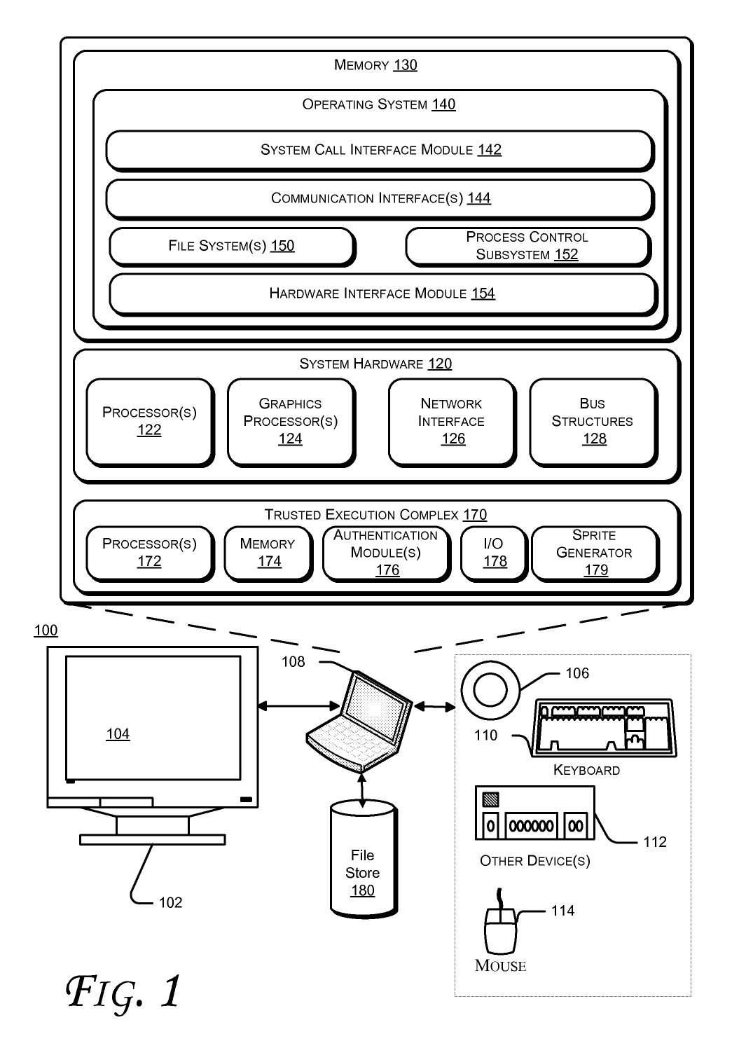

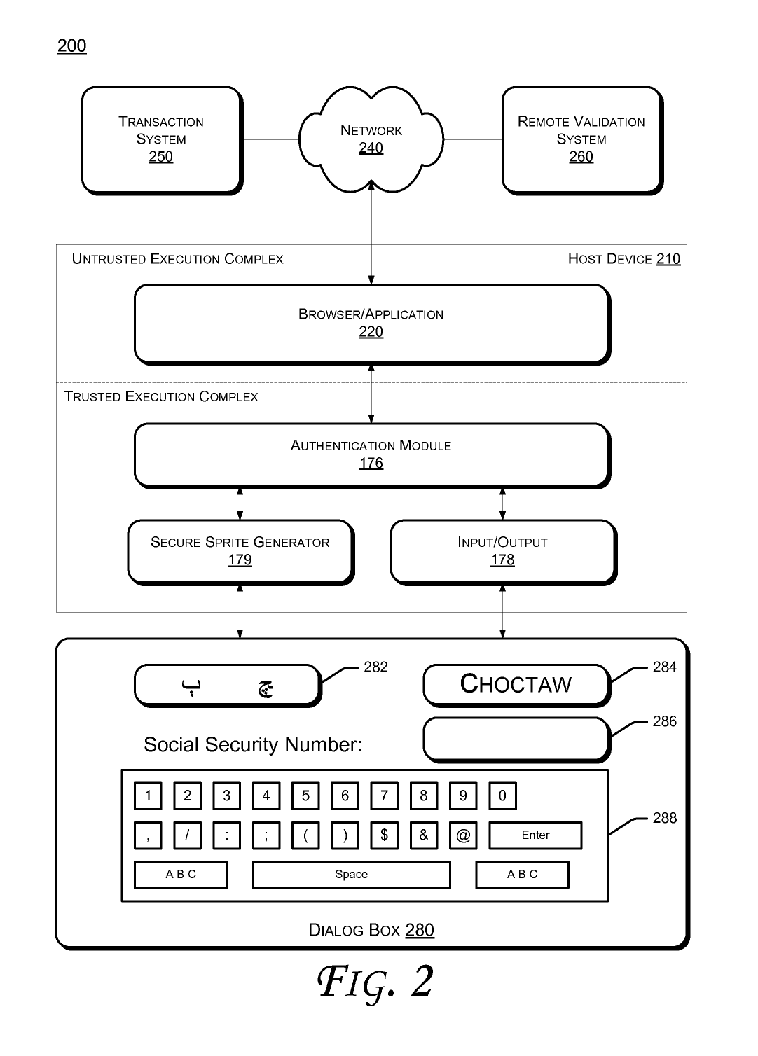

In some embodiments the trusted execution complex may be used to ensure trusted user input for one or more transactions between a host electronic device and a remote computing device, e.g., a online commerce site or the like. FIG. 2 is a high-level schematic illustration of an exemplary architecture for trusted user interaction accordance with some embodiments. Referring to FIG. 2, a host device 210 may be characterized as having an untrusted execution complex and a trusted execution complex. When the host device 210 is embodied as a system 100 the trusted execution complex may be implemented by the trusted execution complex 170, while the untrusted execution complex may be implemented by the main processors(s) 122 and operating system 140 of the system 100. In some embodiments the trusted execution complex may be implemented in a secure portion of the main processor(s) 122. As illustrated in FIG. 2, remote entities that originate transactions, identified as a transaction system in FIG. 2, may be embodied as electronic commerce websites or the like and may be coupled to the host device via a communication network 240. In use, an owner or operator of electronic device 108 may access the transaction system 250 using a browser 220 or other application software via the network to initiate an electronic commerce transaction on the system 250.

The authentication module 176, alone or in combination with the input/output module and the secure sprite generator 179 may implement procedures to ensure trusted user input via a dialog box 280.

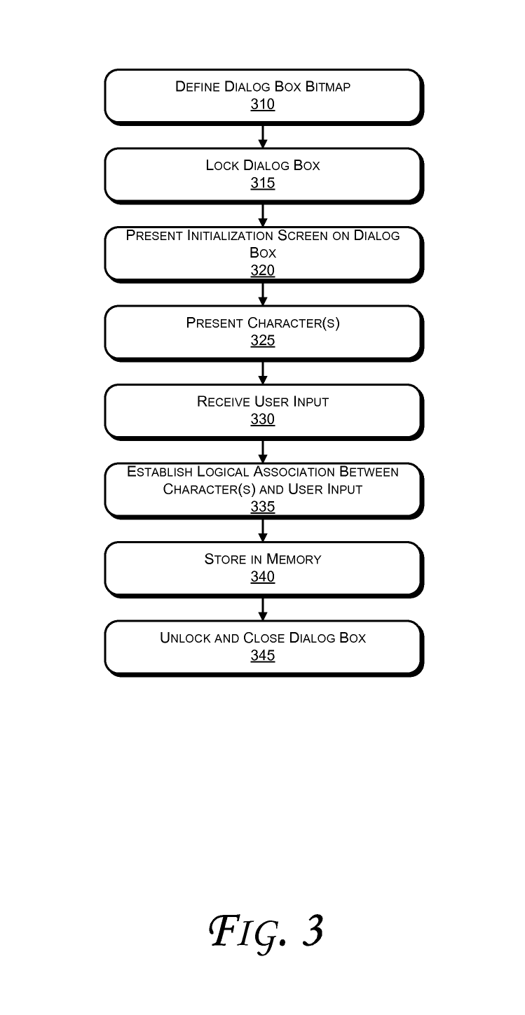

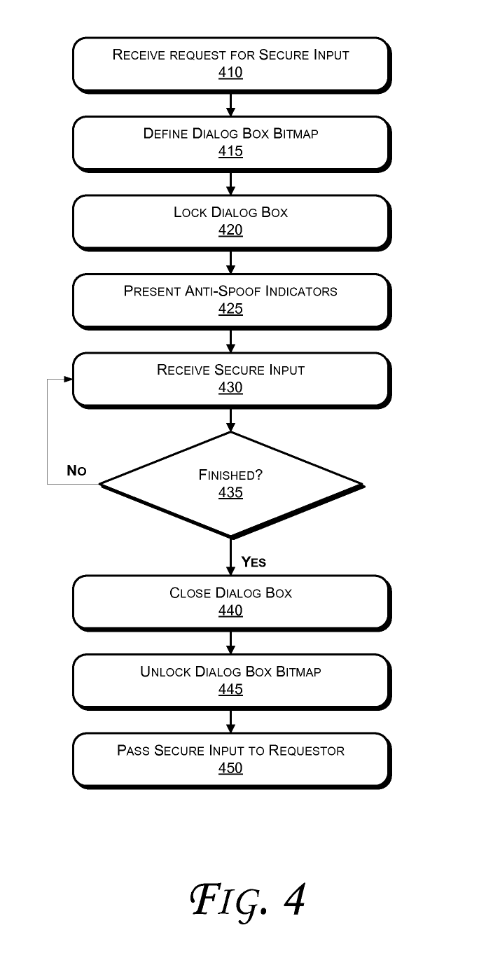

Having described various structures of a system to implement trusted user input, operating aspects of a system will be explained with reference to FIGS. 3-4, which are flowcharts illustrating operations in a method to implement trusted user interaction in accordance with some embodiments. In some embodiments the operations depicted in the flowchart of FIGS. 3-4 may be implemented by the authentication module(s) 176 of the trusted execution complex 170.

By way of overview, in some embodiments the trusted execution complex defines a secure dialog box on a display of an electronic device. During an initialization process the user may select one or more anti-spoof indicators, which may be embodied as characters, images, or the like. In addition, a user may select or enter one or more words or phrases as an anti-spoof indicator. The words or phrases may be logically associated with the characters, images, or the like and stored in a secure memory in the trusted execution complex. In this manner the user's anti-spoof indicators are not subject to being snooped or otherwise discovered by malware or other software operating in the untrusted execution complex.

In operation an application such as, for example, an electronic commerce application, may request confidential information from a user. In response to the request, the authentication module 176 and associated functionality operating in the trusted execution complex may generate a secure dialog box on a display of the electronic device. The anti-spoof indicators may be presented on the dialog box as a way to confirm to the user that the dialog box is generated by the trusted execution complex. The user may input confidential information in the dialog box. The authentication module and associated functionality receives the confidential information and passes it securely to the requesting application.

FIG. 3 depicts operations in an initialization procedure which may be implemented by the trusted execution complex. By way of example, the initialization procedure depicted in FIG. 3 may be implemented when an electronic device is purchased or at any time during the life on an electronic device. Referring to FIG. 3, at operation 310 the secure sprite generator 179 defines a dialog box 280 on a display of the electronic device. At operation 315 the input/output module 178 locks the dialog box 280 such that input/output operations implemented in bitmap of the dialog box are visible only to the trusted execution complex. Once the dialog box is locked input/output operations implemented in the dialog box are not visible to the untrusted execution complex.

At operation 320 an initialization screed may be presented on the dialog box. The initialization screen may present (operation 325) a user with one or more anti-spoof indicators, which may be embodied as characters, images, or the like. The user may input a selection of one or more anti-spoof indicators to be used in conjunction with the dialog box 280 and may also input one or more character strings, words, phrases, or the like.

At operation 330 user input from the dialog box 280 is received in the trusted execution complex. By way of example, the user input may be received in the input/output module 178. At operation 335 a logical association may be established between the character(s) selected by the user, and at operation 340 the anti-spoof characters and the user input may be stored in a memory such as, e.g., the memory 174 in the trusted execution complex 170. At operation 345 the dialog box 280 may be unlocked and closed.

Thus, the initialization process enables a user to select one or more anti-spoof indicators presented on the dialog box 280 and to enter one or more anti-spoof indicators in the dialog box 280. The anti-spoof indicators may be logically associated and stored in memory 174 for subsequent presentation.

FIG. 4 is a flowchart depicting operations in which the trusted execution complex is used to implement trusted user interaction. Referring to FIG. 4, at operation 410 a request is received for secure input from a user of the electronic device. By way of example, in some embodiments the request may be generated by an application executing in the untrusted execution complex of the electronic device such as, e.g., a browser or the like, in response to a request from a remote source such as, for example, a transaction system 250 depicted in FIG. 2. In some embodiments the request may include an identifier which uniquely identifies the requesting application and may also uniquely identify the request. For example, the identifier may include a timestamp which identifies the time at which the request was generated.

In response to the request, at operation 415 the secure sprite generator 179 defines a dialog box 280 on a display of the electronic device. At operation 420 the input/output module 178 locks the dialog box 280 such that input/output operations implemented in bitmap of the dialog box 280 are visible only to the trusted execution complex. Once the dialog box 280 is locked input/output operations implemented in the dialog box 280 are not visible to the untrusted execution complex.

At operation 425 the anti-spoof indicators selected and/or input by the user during the initialization operation are presented. By way of example, the anti-spoof characters selected by the user may be presented in a first window 282, while the user-input may be presented in a second window 284. Because the anti-spoof indicators were stored in secure memory 274 and presented in a locked dialog box 280 the anti-spoofing indicators provide a visual indication that the dialog box 280 is secure.

At operation 430 secure input is received in the dialog box. In the embodiment depicted in FIG. 2 the user is requested to enter his or her social security number in a window 286 of the dialog box using a keyboard 288 generated by the secure sprite generator 179. However, one skilled in the art will recognize that the user may enter other information, e.g., a user identification, password, or the like.

The user can indicate that he or she is finished entering secure input, e.g., by clicking the ENTER button on the keyboard. If at operation 435 the user is finished entering secure input then control passes to operation 440 and the dialog box 280 may be closed and the region of the display on which the dialog box 280 was presented may be unlocked (operation 445).

At operation 450 the secure input collected in the dialog box may be passed from the trusted execution complex to the application operating in the untrusted execution complex that requested the secure input. By way of example, in some embodiments the authentication module 176 establishes a secure communication channel with the application and passes the user input to the application on the secure channel. In addition, in some embodiments the authentication module 176 may verify the identifier and the request with the application, e.g., by confirming that the identifier associated with the application matches the identifier associated with the requesting application and the request.

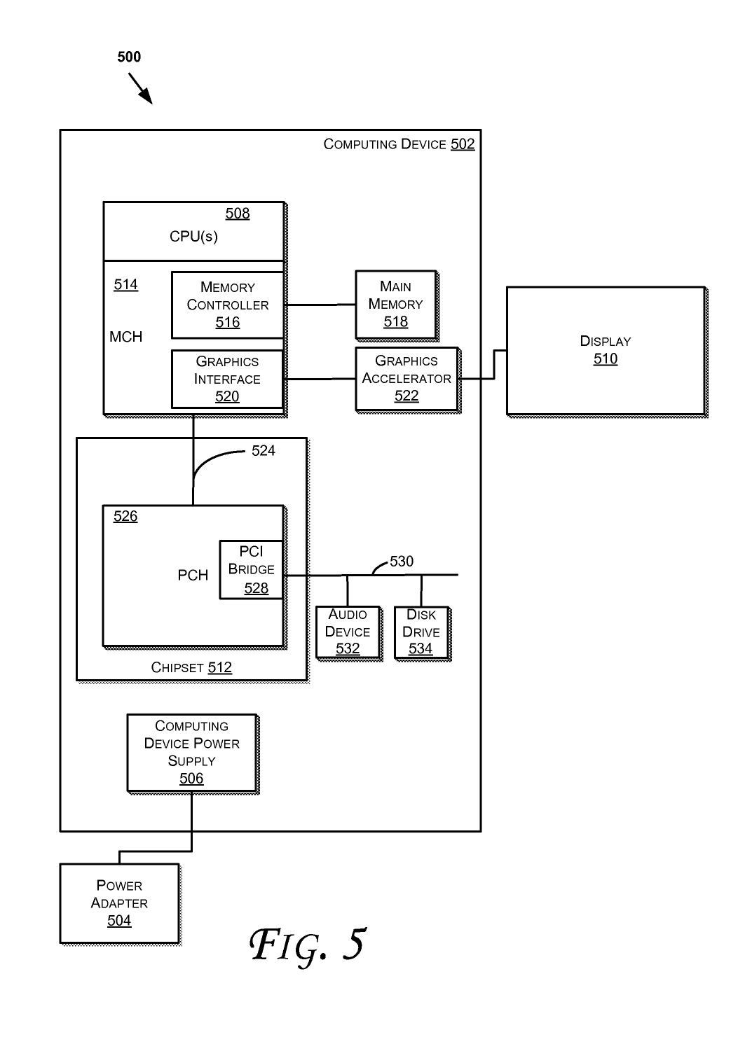

As described above, in some embodiments the electronic device may be embodied as a computer system. FIG. 5 is a schematic illustration of a computer system 500 in accordance with some embodiments. The computer system 500 includes a computing device 502 and a power adapter 504 (e.g., to supply electrical power to the computing device 502). The computing device 502 may be any suitable computing device such as a laptop (or notebook) computer, a personal digital assistant, a desktop computing device (e.g., a workstation or a desktop computer), a rack-mounted computing device, and the like.

Electrical power may be provided to various components of the computing device 502 (e.g., through a computing device power supply 506) from one or more of the following sources: one or more battery packs, an alternating current (AC) outlet (e.g., through a transformer and/or adaptor such as a power adapter 504), automotive power supplies, airplane power supplies, and the like. In some embodiments, the power adapter 504 may transform the power supply source output (e.g., the AC outlet voltage of about 110 VAC to 240 VAC) to a direct current (DC) voltage ranging between about 7 VDC to 12.6 VDC. Accordingly, the power adapter 504 may be an AC/DC adapter.

The computing device 502 may also include one or more central processing unit(s) (CPUs) 508. In some embodiments, the CPU 508 may be one or more processors in the Pentium® family of processors including the Pentium® II processor family, Pentium® III processors, Pentium® IV , CORE2 Duo processors, or Atom processors available from Intel® Corporation of Santa Clara, Calif. Alternatively, other CPUs may be used, such as Intel's Itanium®, XEON™, and Celeron® processors. Also, one or more processors from other manufactures may be utilized. Moreover, the processors may have a single or multi core design.

A chipset 512 may be coupled to, or integrated with, CPU 508. The chipset 512 may include a memory control hub (MCH) 514. The MCH 514 may include a memory controller 516 that is coupled to a main system memory 518. The main system memory 518 stores data and sequences of instructions that are executed by the CPU 508, or any other device included in the system 500. In some embodiments, the main system memory 518 includes random access memory (RAM); however, the main system memory 518 may be implemented using other memory types such as dynamic RAM (DRAM), synchronous DRAM (SDRAM), and the like. Additional devices may also be coupled to the bus 510, such as multiple CPUs and/or multiple system memories.

The MCH 514 may also include a graphics interface 520 coupled to a graphics accelerator 522. In some embodiments, the graphics interface 520 is coupled to the graphics accelerator 522 via an accelerated graphics port (AGP). In some embodiments, a display (such as a flat panel display) 540 may be coupled to the graphics interface 520 through, for example, a signal converter that translates a digital representation of an image stored in a storage device such as video memory or system memory into display signals that are interpreted and displayed by the display. The display 540 signals produced by the display device may pass through various control devices before being interpreted by and subsequently displayed on the display.

A hub interface 524 couples the MCH 514 to an platform control hub (PCH) 526. The PCH 526 provides an interface to input/output (I/O) devices coupled to the computer system 500. The PCH 526 may be coupled to a peripheral component interconnect (PCI) bus. Hence, the PCH 526 includes a PCI bridge 528 that provides an interface to a PCI bus 530. The PCI bridge 528 provides a data path between the CPU 508 and peripheral devices. Additionally, other types of I/O interconnect topologies may be utilized such as the PCI Express™ architecture, available through Intel® Corporation of Santa Clara, Calif.

The PCI bus 530 may be coupled to an audio device 532 and one or more disk drive(s) 534. Other devices may be coupled to the PCI bus 530. In addition, the CPU 508 and the MCH 514 may be combined to form a single chip. Furthermore, the graphics accelerator 522 may be included within the MCH 514 in other embodiments.

Additionally, other peripherals coupled to the PCH 526 may include, in various embodiments, integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like. Hence, the computing device 502 may include volatile and/or nonvolatile memory. Thus, there is described herein an architecture and associated methods to implement trusted user input in electronic devices. In some embodiments the architecture uses hardware capabilities embedded in an electronic device platform to provide assurances to a user that user input is being made in a secure and trusted environment. In the embodiments described herein secure input operations are based on processing that occurs within a trusted environment, separate from the host operating system. The execution environment may be implemented in a trusted execution complex which presents a secure dialog box that includes one or more anti-spoof indicators on a display to provide a user assurance that the input environment is secure. In some embodiments the trusted execution complex may be implemented in a remote device, e.g., a dongle.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “some embodiments” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1-21. (canceled)

22. A controller, comprising:
logic configured to:
receive a request for trusted input from a user;
define, on a region of a display device coupled to the secure controller, a dialog box;
lock the dialog box such that input/output operations conducted in the dialog box are visible only to the secure controller;
present, in the dialog box, one or more anti-spoof indicators and at least one input mechanism;
receive a user input from the at least one input mechanism; and
process the user input in the secure controller.

23. The controller of claim 22, wherein the logic is further configured to:
establish an association between two or more anti-spoof indicators; and
display the two or more associated anti-spoof indicators in the dialog box.

24. The controller of claim 22, wherein the logic is further configured to:
receive an indication that input operations in the dialog box are complete, and in response the input, to:
close the dialog box; and
unlock the region of the display device on which the dialog box was defined.

25. The controller of claim 22, wherein the logic is further configured to:
define, on a region of a display device coupled to the secure controller, a dialog box;
present, on the dialog box, one or more anti-spoof indicators;
receive, via the dialog box, an input; and
establish a logical association between the one or more anti-spoof indicators and the input received in the dialog box.

26. The controller of claim 22, wherein:
the request for trusted input from the user is received from an application executing on a processor coupled to the secure controller; and
the request includes an identifier which uniquely identifies the application and the request.

27. The controller of claim 26, wherein the logic is further configured to:
establish a secure channel between the secure controller and the application executing on the processor coupled to the secure controller; and
pass the user input from the secure controller to the application via the secure channel.

28. The controller of claim 27, wherein the logic to establish a secure channel between the secure controller and the application executing on the processor coupled to the secure controller comprises logic to verify the identifier and the request with the application.

29. An electronic device, comprising:
a display;
a processor;
an operating system executable on the processor to implement an untrusted computing environment; and
a controller comprising:
logic configured to:
receive a request for trusted input from a user;
define, on a region of a display device coupled to the secure controller, a dialog box;
lock the dialog box such that input/output operations conducted in the dialog box are visible only to the secure controller;
present, in the dialog box, one or more anti-spoof indicators and at least one input mechanism;
receive a user input from the at least one input mechanism; and
process the user input in the secure controller.

30. The electronic device of claim 29, wherein the logic is further configured to:
establish an association between two or more anti-spoof indicators; and
display the two or more associated anti-spoof indicators in the dialog box.

31. The electronic device of claim 29, wherein the logic is further configured to:
receive an indication that input operations in the dialog box are complete, and in response the input, to:
close the dialog box; and
unlock the region of the display device on which the dialog box was defined.

32. The electronic device of claim 29, wherein the logic is further configured to:
define, on a region of a display device coupled to the secure controller, a dialog box;
present, on the dialog box, one or more anti-spoof indicators;
receive, via the dialog box, an input; and
establish a logical association between the one or more anti-spoof indicators and the input received in the dialog box.

33. The electronic device of claim 29, wherein:
the request for trusted input from the user is received from an application executing on a processor coupled to the secure controller; and
the request includes an identifier which uniquely identifies the application and the request.

34. The electronic device of claim 33, wherein the logic is further configured to:
establish a secure channel between the secure controller and the application executing on the processor coupled to the secure controller; and
pass the user input from the secure controller to the application via the secure channel.

35. The electronic device of claim 34, wherein the logic to establish a secure channel between the secure controller and the application executing on the processor coupled to the secure controller comprises logic to verify the identifier and the request with the application.

36. A computer program product comprising logic instructions stored on a tangible computer readable medium which, when executed by a secure controller, configure the secure controller to:
receive a request for trusted input from the user;
define, on a region of a display device coupled to the secure controller, a dialog box;
lock the dialog box such that input/output operations conducted in the dialog box are visible only to the secure controller;
present, in the dialog box, one or more anti-spoof indicators and at least one input mechanism;
receive a user input from the input mechanism; and
process the user input in the secure controller.

37. The computer program product of claim 36, further comprising logic instructions stored on a tangible computer readable medium which, when executed by a secure controller, configure the secure controller to:
establish an association between two or more anti-spoof indicators; and
display the two or more associated anti-spoof indicators in the dialog box.

38. The computer program product of claim 36, further comprising logic instructions stored on a tangible computer readable medium which, when executed by a secure controller, configure the secure controller to:
receive an indication that input operations in the dialog box are complete, and in response the input, to:
close the dialog box; and
unlock the region of the display device on which the dialog box was defined.

39. The computer program product of claim 36, further comprising logic instructions stored on a tangible computer readable medium which, when executed by a secure controller, configure the secure controller to:
define, on a region of a display device coupled to the secure controller, a dialog box;
present, on the dialog box, one or more anti-spoof indicators;
receive, via the dialog box, an input; and
establish a logical association between the one or more anti-spoof indicators and the input received in the dialog box.

40. The computer program product of claim 39, wherein:
the request for trusted input from the user is received from an application executing on a processor coupled to the secure controller; and
the request includes an identifier which uniquely identifies the application and the request.

41. The computer program product of claim 34, further comprising logic instructions stored on a tangible computer readable medium which, when executed by a secure controller, configure the secure controller to:
establish a secure channel between the secure controller and the application executing on the processor coupled to the secure controller; and
pass the user input from the secure controller to the application via the secure channel.

42. The computer program product of claim 41, wherein the logic to establish a secure channel between the secure controller and the application executing on the processor coupled to the secure controller comprises logic to verify the identifier and the request with the application.
